(19) United States
(12) Patent Application Publication
(10) Pub. No.: US 2025/0300160 A1
(43) Pub. Date: Sep. 25, 2025

(54) SURFACE TREATMENT OF LITHIUM-ION BATTERY COMPONENTS

(71) Applicant: FORD GLOBAL TECHNOLOGIES, LLC, Dearborn, MI (US)

(72) Inventors: DongHyun LEE, Northville, MI (US); Gary Thomas MARTINI, Dexter, MI (US); Ann Marie STRACCIA, Southgate, MI (US); Paul John BOJANOWSKI, Macomb Township, MI (US); Se Hyun KIM, Ann Arbor, MI (US); Michael ORR, Ferndale, MI (US)

(21) Appl. No.: 18/614,000

(22) Filed: Mar. 22, 2024

(51) Int. Cl. H01M 4/04; H01M 4/66

(52) U.S. Cl. CPC H01M 4/0435; H01M 4/0404; H01M 4/661

(57) ABSTRACT

The disclosure relates to manufacturing methods for forming electrodes. In one method provided, an oxidized layer from a surface of a metal current collector is removed via ionization. A solvent-free dry powder agglomeration of active materials, binders, and conductive agents is then calendared onto the surface of the metal current collector to form an electrode.

### TECHNICAL FIELD

In at least one aspect, methods for manufacture of lithium-ion batteries are provided.

### BACKGROUND

The manufacturing of battery electrodes traditionally utilizes a wet process involving solvents, necessitating long drying times and solvent recycling systems. This process, despite its widespread use, poses some concerns. The dry electrode process emerged as an alternative to address these issues by eliminating the need for solvents, thereby simplifying the manufacturing process.

Utilizing the dry process, however, may have its own challenges such as reduced adhesive force between the composite material layer and the metal substrate, which may lead to delamination. This delamination may affect battery performance, increasing resistance and reducing energy capacity and lifespan. Attempts to increase adhesion, such as applying carbon primer coatings or etching the metal surface, have been explored but introduce additional processing steps.

### SUMMARY

In one aspect of the disclosure, a manufacturing method is presented. The manufacturing method includes removing an oxidized layer from a surface of a metal current collector via ionization, then calendaring a solvent-free dry agglomeration of active materials, binders, and conductive agents onto the surface of the metal current collector to form an electrode. The ionization source may be a laser. The surface and the ionization source may be separated at a distance with a range of 0 to 1.25 m. The metal current collector may be a foil. In embodiments where the metal current collector is a foil it may be an aluminum foil or a copper foil. The manufacturing method may further comprise cutting the electrode into individual electrode assemblies.

In another aspect of the disclosure, another manufacturing method is presented. The manufacturing method includes ionizing a surface of a metal foil current collector, and bonding a solvent-free agglomeration of active materials, binders, and conductive agents to the surface of the metal current collector to form an electrode. The ionization source may be a laser. The surface and the ionization source may be separated at a distance with a range of 0 to 1.25 m. The metal current collector may be a foil. In embodiments where the metal current collector is a foil, it may be an aluminum foil or a copper foil. The manufacturing method may further comprise cutting the electrode into individual electrode assemblies. The bonding may include laminating, and in other embodiments the bonding may include calendaring.

In another aspect of the disclosure, another manufacturing method is presented. The manufacturing method includes oxidizing a surface of a metal current collector through exposure to an ionization source and laminating a solvent-free dry powder agglomeration of active materials, binders, and conductive agents onto the surface of the metal current collector to form an electrode. The ionization source may be a laser. The metal current collector may be a foil. The manufacturing method may further comprise cutting the electrode into individual electrode assemblies.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 is a schematic illustration of a manufacturing apparatus according to one or more aspects of the disclosure;

FIGS. 2A and 2B are schematic views of a battery component according to one or more embodiments of the disclosure;

FIG. 3 is a flowchart of a manufacturing method according to one or more embodiments of the disclosure;

FIG. 4 is a flowchart of a manufacturing method according to one or more embodiments of the disclosure; and

FIG. 5 is a flowchart of a manufacturing method according to one or more embodiments of the disclosure.

### DETAILED DESCRIPTION

Reference will now be made in detail to presently preferred compositions, embodiments, and methods of the present invention. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

This disclosure relates to an approach designed to increase the efficiency and reduce the overhead associated with battery manufacturing. A continuous in-line process that eschews the addition of extraneous materials is contemplated. The process is distinguished by its utilization of in-line surface treatment for metal foils, a component in the construction of batteries. In one aspect of the disclosure, a technique for surface treatment involving the application of laser or other light sources, either singly or in combination is presented. This method is engineered to activate binder materials on the surface of the composite film, thereby increasing the adhesive force between layers. Such enhancement is pivotal for reducing inter-layer resistance, which in turn, contributes to superior battery performance.

One of the advantages of this approach is its potential to streamline the manufacturing process, reducing both time and energy associated with production. By focusing on the activation of binder materials through surface treatment, the processes aim to eliminate the need for additional materials, simplifying the manufacturing pipeline.

Moreover, the adaptability of the process to utilize various light sources for surface treatment offers flexibility in application, ensuring that it can be tailored to meet specific manufacturing needs. This adaptability extends to the treatment of different metal foil materials, such as aluminum and copper, highlighting the method's versatility.

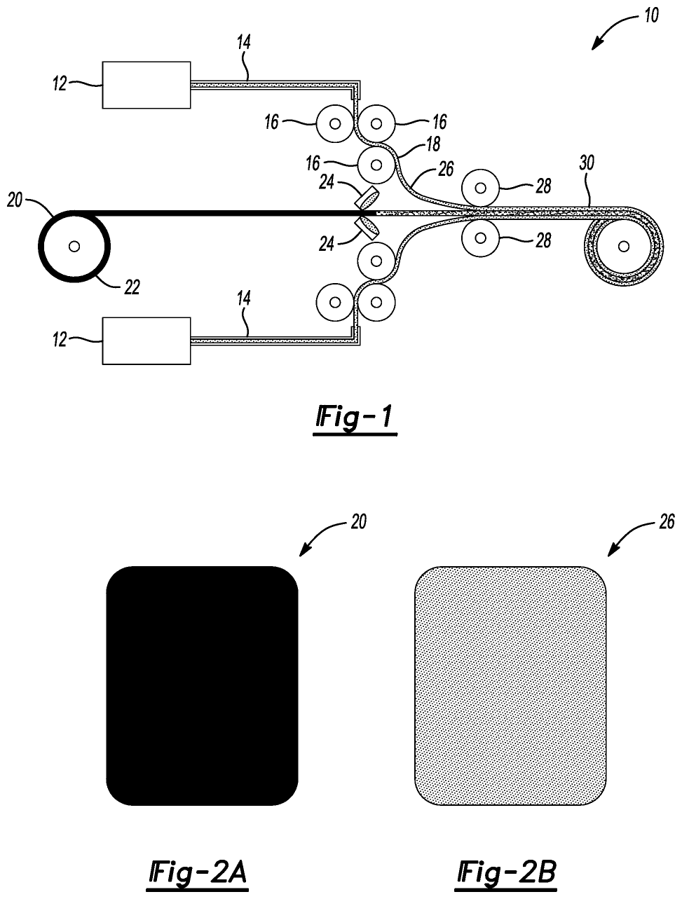

Referring now to FIGS. 1-2B, FIG. 1 shows a manufacturing apparatus 10, as outlined in one or more aspects of the disclosure. The apparatus includes an initial reactor 12 for the dry mixing of active materials, binders, and conductive agents, resulting in a dry powder mixture 14. This mixture is then processed by rollers 16 into an active material layer 18. Simultaneously, a web foil 20, unwound at roller 22, undergoes surface treatment by an ionization source 24, which may be a laser, plasma, or corona source. This step increase surface adhesion of the web foil 20 by ionizing or oxidizing its surface. The foil 20 may be made from a variety of metals such as aluminum, copper, or any other suitable material. Following surface treatment, the active material layer 18 is combined with the treated web foil 26 by calendaring at rollers 28, producing an electrode 30. The treatment process, aimed at increasing adhesion, entails eliminating an oxidized layer from the foil with the ionization source 24, set a specific distance away to effectively treat the foil's surface, now referred to as the treated web foil 26. As shown the surface treatment and calendaring may be done to both sides of the foil 20 which enables the fabrication of two-sided electrodes. However, this process may be similarly applied for single sided electrodes.

FIG. 2A shows the web foil 20 prior to surface treatment, in its initial state with a relatively smooth and potentially oxidized surface that might limit adhesion with the active material layer 20. FIG. 2B shows the treated web foil 26 following the application of the ionization source 24, which may be a laser, plasma, or corona source. The treated foil 26 has changes in the surface texture of the foil, including increased roughness and the creation of microstructures that increase surface adhesion. These modifications result from the removal of the oxidized layer and an increase of the foil's surface area, thereby increasing the bonding capacity with the active material layer 18 for electrode construction.

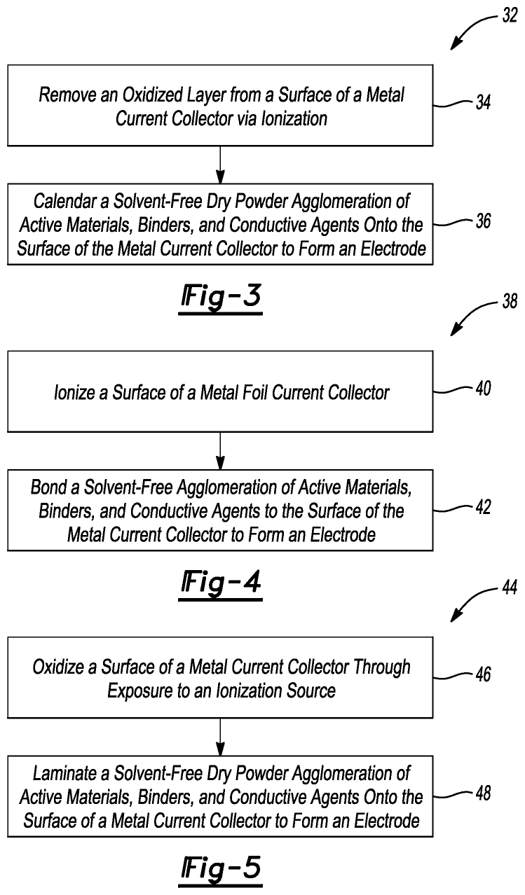

FIG. 3 shows a flowchart of a manufacturing method 32 according to one or more embodiments of the disclosure. Initially, at step 34, an oxidized layer is removed from the surface of a metal current collector via ionization, this step may affect the electrical and mechanical properties of the metal current collector. This process involves using an ionization source, such as a laser, which may be controlled for the effective removal of an oxidized layer without altering the underlying current collector. The optimal distance between the surface and the ionization source may be maintained within a range of 0 to 1.25 meters for uniform oxidization removal. In a final step 36, a solvent-free dry powder agglomeration of active materials, binders, and conductive agents is calendared onto the surface of the metal current collector to form an electrode.

FIG. 4 shows a flowchart of manufacturing method 38 according to one or more embodiments of the disclosure. Initially, at step 40, the surface of a metal foil current collector is ionized. This step may remove impurities and modify the surface structure, potentially increasing its ability to bond with an electrode material. This process may involve using an ionization source, such as a laser, which may be controlled for effective surface modification without altering the underlying current collector. The laser may be focused on a distance between the surface and the ionization source within a range of 0 to 1.25 meters for uniform treatment.

In a final step 42, a solvent-free agglomeration of active materials, binders, and conductive agents is bonded to the ionized surface of the metal current collector to form an electrode. This bonding may be achieved through methods such as laminating or calendaring based on the desired characteristics in electrode production. The method 34 may be applicable to a variety of current collectors such as foil current collectors including those made from aluminum or copper. The method may also include a further step of cutting the electrode into individual assemblies for practical application in battery manufacture.

FIG. 5 shows a flowchart 44 according to one or more embodiments of the disclosure. At step 46, the surface of a metal current collector is oxidized through exposure to an ionization source. This step intentionally oxidizes the surface, which may affect the electrical and mechanical properties of the metal current collector. The ionization source, such as a laser, may be precisely controlled for the effective oxidation of the surface without altering the underlying current collector. The optimal distance between the surface and the ionization source may be maintained within a range of 0 to 1.25 meters for uniform oxidation.

In a final step 48, a solvent-free dry powder agglomeration of active materials, binders, and conductive agents is laminated onto the oxidized surface of the metal current collector to form an electrode. This process involves bonding the agglomeration to the current collector, potentially increasing the adhesion and uniformity of the electrode layer. The current collector may be any suitable current collector, such as aluminum or copper. This method may also include cutting the electrode into individual assemblies for application in battery manufacturing.

Throughout this specification, including the claims which follow, unless explicitly described otherwise, the word “comprises” and variations such as “comprises” or “comprising” will be understood to imply the inclusion of stated elements, steps, or components, but not the omission of any other elements, steps, components, or groups thereof. This interpretation also applies to the terms “include” and “have” and their derivatives.

The term “about,” when used in conjunction with numerical values in this document, refers to variations in the specified amount by +5%, unless otherwise stated. This term is intended to encompass minor variations that may arise due to manufacturing tolerances or measurement inaccuracies. For instance, “about 50” should be interpreted to mean from 47.5 to 52.5.

The term “substantially free” as utilized herein refers to compositions, methods, or articles that lack the specified component (e.g., a solvent) or that have only insignificant amounts of the component such that the absence does not materially affect the basic or novel characteristics of the composition, method, or article. For example, a process described as “substantially free of solvents” implies that solvents are not present.

As employed in this specification and the appended claims, the singular forms “a,” “an,” and “the” include plural referents unless the context dictates otherwise. For example, reference to “a binder” includes a single binder as well as a mixture of two or more binders. The usage of “and/or” in this document is intended to encompass both the conjunctive and disjunctive forms of the terms it connects. That is, “A and/or B” should be understood to mean “A, B, or A and B.”

“Operatively connected” or “operationally coupled,” as used herein, refer to a configuration of elements wherein the elements are arranged such that they can cooperate or interact to achieve a desired function or result. This term is intended to encompass direct connections, indirect connections through intermediate elements, and wireless connections.

Within the context of this disclosure, “enhanced” refers to qualitative and quantitative changes in a property or performance characteristic when compared to a baseline or standard process, composition, or device. For example, “enhanced adhesion” denotes a measurable increase in the bond strength between two materials, achieved through the methods described herein.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A manufacturing method comprising:
removing an oxidized layer from a surface of a metal current collector via ionization; and
calendaring a solvent-free dry powder agglomeration of active materials, binders, and conductive agents onto the surface of the metal current collector to form an electrode.

2. The manufacturing method of claim 1 wherein a source for the ionization is a laser.

3. The manufacturing method of claim 1 wherein the surface and a source for the ionization are separated at a distance with a range of 0 to 1.25 m.

4. The manufacturing method of claim 1 wherein the metal current collector is a foil.

5. The manufacturing method of claim 4 wherein the foil is an aluminum foil.

6. The manufacturing method of claim 4 wherein the foil is a copper foil.

7. The manufacturing method of claim 1 further comprising cutting the electrode into individual electrode assemblies.

8. A manufacturing method comprising:
ionizing a surface of a metal current collector; and
bonding a solvent-free agglomeration of active materials, binders, and conductive agents to the surface of the metal current collector to form an electrode.

9. The manufacturing method of claim 8 wherein a source for the ionizing is a laser.

10. The manufacturing method of claim 8 wherein the surface and a source for the ionizing are separated at a distance with a range of 0 to 1.25 m.

11. The manufacturing method of claim 8 wherein the metal current collector is a foil.

12. The manufacturing method of claim 11 wherein the foil is an aluminum foil.

13. The manufacturing method of claim 11 wherein the foil is a copper foil.

14. The manufacturing method of claim 8 further comprising cutting the electrode into individual electrode assemblies.

15. The manufacturing method of claim 8 wherein the bonding includes laminating.

16. The manufacturing method of claim 8 wherein the bonding includes calendaring.

17. A manufacturing method comprising:
oxidizing a surface of a metal current collector through exposure to an ionization source; and
laminating a solvent-free dry powder agglomeration of active materials, binders, and conductive agents onto the surface of the metal current collector to form an electrode.

18. The manufacturing method of claim 17 wherein the ionization source is a laser.

19. The manufacturing method of claim 17 wherein the metal current collector is a foil.

20. The manufacturing method of claim 17 further comprising cutting the electrode into individual electrode assemblies.
